(19) United States
(12) Patent Application Publication
(10) Pub. No.: US 2008/0087340 A1
(43) Pub. Date: Apr. 17, 2008

(54) PRIMARY/SECONDARY LOOP PURGE VALVE

(76) Inventor: Michael E. Reck, Worcester, MA (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 11/929,002

(22) Filed: Oct. 30, 2007

Related U.S. Application Data
(63) Continuation-in-part of application No. 11/648,376, filed on Dec. 29, 2006.
(60) Provisional application No. 60/756,007, filed on Jan. 4, 2006.

(51) Int. Cl. F16K 1/00

(52) U.S. Cl. 137/614.2

(57) ABSTRACT

This invention comprises a purge valve comprising a valve body having a first primary loop port and a second primary loop port, the valve body defining a first secondary loop port and second secondary loop port, the valve body defining a flow channel and a valve portion, the valve portion in communication with the first, second, third, and forth port and a flow diversion device disposed within the valve portion, the flow diversion device configurable between a first and second position such that when the flow diversion device is in the first position the first primary loop port is in communication with the second primary loop port, the first secondary loop port and the second secondary loop port and when the flow diversion device is in a second position the first primary loop port is in communication with the first secondary loop port only and the second primary loop port is in communication with the second secondary loop port only.

### CROSS REFERENCE TO RELATED APPLICATIONS

This is a continuation in part (CIP) of U.S. patent application Ser. No. 11/648,376 filed on Dec. 29, 2006 which claims the benefit of U.S. Provisional Patent Application Ser. No. 60/756,007, filed on Jan. 4, 2006, the contents of which being incorporated herein by reference in its entirety.

### FIELD OF INVENTION

The present invention relates to valves, particularly to a primary/secondary loop purge valve.

### BACKGROUND OF INVENTION

Primary/secondary (“P/S”) piping systems are used to isolate the pressure differential established by a pump from those established by other pumps in the same system. P/S piping allows any pump in the system to operate with virtually no tendency to induce flow, or even disturb flow, in other loops. P/S piping systems have become increasingly popular in many commercial and residential plumbing systems, such as hydronic heating and cooling systems. In such systems purge valves are essential to the operation and maintenance of the systems. Hydronic heating systems have gained popularity due to the comfortable average temperature they provide and due to minimal stratification. Hydronic systems use water, or water-based solutions, to move thermal energy from where it is produced to where it is needed. Thermal energy is absorbed by the water at a heat source, conveyed by the water through the distribution piping, and finally released into a heated space by a heat emitter. Because hydronic heating and cooling systems rely on the flow of water through the pipes, the presence of air bubbles or pockets within the piping can lead to inefficiency and malfunction of the system. Purge valves are used to empty the system of air upon installation and during maintenance to provide for a more efficient system. Previous systems utilized purge valves located on the secondary loop in order to remove air from the secondary loop. The use of such valves can lead to pressure differentials that can affect the operation of the remainder of the system.

### SUMMARY OF INVENTION

A P/S loop purge valve that allows for the elimination of air from a piping system with no discernable pressure decrease is disclosed. The valve allows for power purging off a secondary loop in the installation of hydronic systems. An embodiment of the present invention includes a valve body containing a flow channel extending through the body from a first primary loop port to a second primary loop port. The valve body also contains first and second secondary loop ports in communication with the flow channel. A flow diversion device is disposed in the valve body to control and alter the flow channel through the various ports of the valve body. The flow diversion device is disposed within the flow channel between the first and second secondary loop ports. The flow diversion device in a first position allows open flow through all ports of the valve. In a second position, the flow diversion device directs flow from the first primary loop port to the first secondary loop port and flow from the second secondary loop port to the second primary loop port.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is an axial view of an embodiment in accordance with the present invention;

FIG. 2 is a cut-away side view of an embodiment in accordance with the present invention;

FIG. 3 is a top-down cut-away view of an embodiment in accordance with the present invention;

FIG. 4 is a top-down cut-away view having a flow diversion device disposed within the first and second secondary loop ports; and

FIG. 5 is a top-down cut-away view having multiple flow diversion devices disposed within the primary loop.

### DETAILED DESCRIPTION

Detailed embodiments of the present invention are disclosed herein, however, it is to be understood that the disclosed embodiments are merely exemplary of the invention, which may be embodied in various forms. Therefore, specific functional or structural details disclosed herein are not to be interpreted as limiting, but merely as a basis for the claims and as a representative basis for teaching one skilled in the art to variously employ the present invention in virtually any appropriately detailed embodiment.

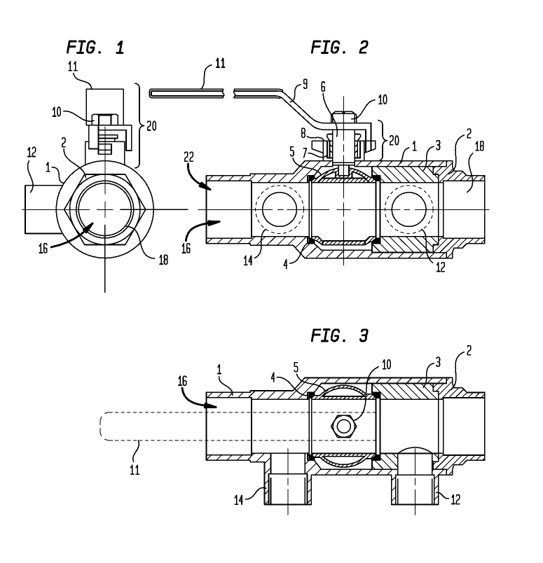

Turning to FIG. 1, an axial view of an embodiment in accordance with the present invention is shown. A valve body 1 defines a flow channel 16 that extends axially through the valve body 1 from a first primary loop port 18 to a second primary loop port. The valve body 1 also defines a first secondary loop port 12 and a second secondary loop port (not shown). An end cap 2 is affixed to the valve body 1 at the first primary loop port 18. An actuator 20 extends from the valve body 1 enabling a first and second position of the valve. The actuator 20 includes a handle 11 affixed to the valve body by a handle nut 10. A flow diversion device (not shown here) is connected to the handle 11. The position of the actuator 20 in a first position configures the flow diversion device to allow flow axially through the entire flow channel 16 from the first primary loop port to the second primary loop flow port as well as through the first and second secondary loop flow ports. In a second position of the actuator 20, the flow diversion device blocks the flow from the first primary loop port 18 to the second primary loop port. In this position, the first primary loop port 18 is in fluid communication with the first secondary loop port 12 only and the second primary loop port is in fluid communication with the second secondary loop port only. In a hydronic piping system, the valve in this position will break the primary loop and force all flow into the secondary loop. This position is used in such systems to purge the secondary loop of air during installation or maintenance.

Turning now to FIG. 2 and FIG. 3, cut-away views of an embodiment of the present invention are shown. FIG. 2 depicts the embodiment from a side-view, while FIG. 3 depicts the embodiment from a top-view. A valve body 1 defines a flow channel 16 axially though the valve from the first primary loop port 18 to the second primary loop port 22. The first secondary loop port 12 and the second secondary loop port 14 are also in fluid communication with the flow channel 16. The end cap 2 is disposed into the valve body 1 and mated with a seat retainer 3. The actuator 20 extends from the valve body 1 containing a stem 6, a stem seal 7 and a packing gland 8. The actuator 20 also includes a handle 11 that is affixed to the stem 6 with the handle nut 10. The actuator 20 repositions the flow diversion device 5 to alter the flow channels of the valve. The flow diversion device 5 is disposed within the valve body 1 in between the first secondary loop port 12 and the second secondary loop port 14. The flow diversion device in this embodiment includes a ball defining two openings equal in diameter to the diameter of the flow channel 16. The flow diversion device 5 is disposed between valve seats 4. The position of the actuator 20 in a first position positions the flow diversion device to allow flow axially through the entire flow channel 16 from the first primary loop port to the second primary flow port as well as through the first and second secondary flow ports. In a second position of the actuator 20, the flow diversion device blocks the flow from the first primary port 18 to the second primary port. In this position, the first primary loop port 18 is in fluid communication with the first secondary loop port 12 only and the second primary loop port is in fluid communication with the second secondary loop port only.

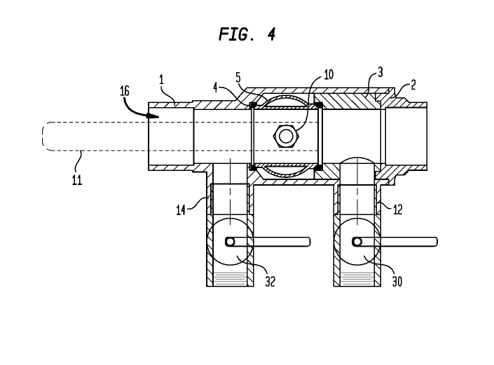

An alternative embodiment of the present invention is described with reference to FIG. 4 which is similar to the embodiment shown in FIG. 3 but also includes a flow diversion device disposed within each of the first and second secondary loop ports 12, 14. A valve body 1 defines a flow channel 16 axially though the valve from the first primary loop port 18 to the second primary loop port 22. The first secondary loop port 12 and the second secondary loop port 14 are also in fluid communication with the flow channel 16. A first secondary flow diversion device 30 is disposed within the first secondary loop port and is configurable to a first position which closes the first secondary loop port and to a second position which opens the first secondary loop port. A second secondary flow diversion device 32 is disposed within the second secondary loop port and is configurable to a first position which closes the second secondary loop port and to a second position which opens the second secondary loop port.

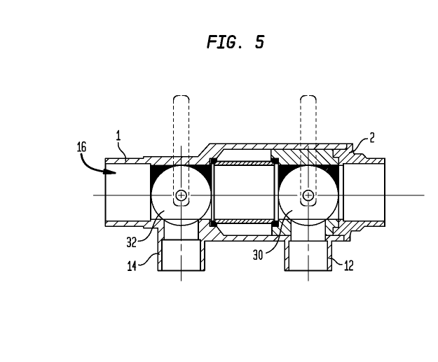

In an alternative embodiment illustrated in FIG. 5 the primary/secondary loop valve includes multiple valves in the primary loop to effect flow in the primary and secondary loops. The multiple flow diversion devices, 30, 32 are disposed in the primary flow channel 16 at the intersections of the primary and secondary flow paths. The flow diversion devices are configured, as described hereinbefore, to alternately provide flow through at least one of the primary and secondary loops.

The present invention also provides a method of purging a primary loop in a primary/secondary plumbing system using the inventive loop purge valve by connecting the first secondary loop port to a flushing fluid source and actuating the primary flow diversion device to configures the primary flow diversion device in its second position to close the flow path between the first primary loop port and second primary loop port. The first secondary flow diversion device is configured in the second position to allow the flushing fluid to flow into the first secondary loop port before flowing through the primary loop and the second secondary flow diversion device is configured in the second position to allow the flushing fluid to flow out from the second secondary loop port after flowing through the primary loop. Upon completion of the purging procedure, each of the flow diversion devices can be configured to their respective first positions.

Although one illustrative embodiment described herein includes diversion devices in both of the secondary loop ports and in the primary loop path, one skilled in the art should appreciate that other configurations of diversion devices can be implemented, such as a diversion device in each of the first and second primary loop ports, or in other combinations, such as a diversion device at inputs and/or outputs of the loop ports (primary and/or secondary).

It should also be appreciated that a “diversion device” can be one or more devices for diverting flow in a desired manner.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

1. A purge valve comprising:
a valve body having a first primary loop port and a second primary loop port, the valve body defining a first secondary loop port and second secondary loop port, the valve body defining a flow channel and at least one valve portion, the at least one valve portion in communication with the first primary loop port, second primary loop port, first secondary loop port and second secondary loop port;
a primary flow diversion device configurable between a first and second position such that when the primary flow diversion device is in the first position the first primary loop port is in communication with the second primary loop port, the first secondary loop port and the second secondary loop port and when the primary flow diversion device is in a second position the first primary loop port is in communication with the first secondary loop port and the second primary loop port is in communication with the second secondary loop port, wherein in the second position, the primary flow diversion device closes a flow channel between the first and second primary loop ports and between the first and second secondary loop ports;
a secondary flow diversion device configurable to control flow between said first secondary loop port and said second secondary loop port.

2. The purge valve of claim 1 wherein the secondary flow diversion device comprises two flow diversion device, including a first secondary flow diversion device disposed within the first secondary loop port; and a second secondary flow diversion device disposed within the second secondary loop port.

3. The purge valve of claim 1 wherein the primary flow diversion device is a single ball valve disposed within the valve portion.

4. The purge valve of claim 2, wherein at least one of the primary flow diversion device, the first secondary flow diversion device and the second secondary flow diversion device is a ball valve.

5. The purge valve of claim 2, wherein the first secondary flow diversion device is adapted to open or close the first secondary loop port and the second secondary flow diversion device is adapted to open or close the second secondary loop port.

6. The purge valve of claim 2, wherein the valve body is monolithically constructed to include the first and second secondary loop ports and wherein at least one of the first secondary flow diversion device and the second secondary flow diversion device is disposed within the monolithically constructed valve body.

7. The purge valve of claim 1, wherein the first and second secondary loop ports have respective first and second secondary flow diversion devices removably attached to the valve body.

8. A method of purging a primary loop in a primary/secondary plumbing system comprising:
configuring a primary flow diversion device in a valve body having a first primary loop port and a second primary loop port in the primary loop, the valve body defining a first secondary loop port and second secondary loop port, the valve body defining a flow channel and a valve portion, the valve portion in communication with the first primary loop port, second primary loop port, first secondary loop port and second secondary loop port;
actuating the primary flow diversion device between a first and second position such that when the primary flow diversion device is in the first position the first primary loop port is in communication with the second primary loop port, the first secondary loop port and the second secondary loop port and when the primary flow diversion device is in a second position the first primary loop port is in communication with the first secondary loop port and the second primary loop port is in communication with the second secondary loop port, wherein in the second position, the primary flow diversion device closes a flow channel between the first and second primary loop ports and between the first and second secondary loop ports;
configuring a secondary flow diversion device in at least one of the first secondary loop port and the second secondary loop port;
actuating one of the primary and secondary flow diversion device to allow a flushing fluid to flow into the first secondary loop port before flowing through the primary loop; and
actuating one of the primary and secondary flow diversion device to allow the flushing fluid to flow out from the second secondary loop port after flowing through the primary loop.
